(19) United States
(12) Patent Application Publication
(10) Pub. No.: US 2011/0253292 A1
(43) Pub. Date: Oct. 20, 2011

(54) Method for Manufacturing a Ball Casing

(76) Inventor: Willy Chen, Taipei County (TW)

(21) Appl. No.: 12/818,209

(22) Filed: Jun. 18, 2010

(30) Foreign Application Priority Data
Apr. 19, 2010 (TW) 099112178

(51) Int. Cl. B29C 65/72; B29C 65/62; B29C 65/48; B32B 38/04

(52) U.S. Cl. 156/93; 156/256

(57) ABSTRACT

A method for manufacturing a ball casing by piecing together plural sections is disclosed. The method includes the steps of: (1) providing a material having a protection layer and a fiber layer adhering therewith; (2) cutting the material into sections and (3) piecing together the sections to form a ball casing.

### BACKGROUND OF THE INVENTION

1. Technical Field

The invention generally relates to balls, particularly to balls for competition or recreation.

2. Related Art

Traditional balls for competition will become heavy when once they touch water. Thus those balls are not suitable for the competitions or games relative to water. A ball is essentially composed of a bladder and a casing outside the bladder. An exemplary structure is shown in U.S. Pat. No. 5,997,422. The ball of '422 has an inner inflatable bladder and an outer casing pieced up by four panels.

The panels of '422 have a multi-layer structure which includes a first layer, a second layer and a third layer. The first layer is a surface layer made of plastic or resin and capable of water resistance. The second layer is a fiber layer attaching the first layer. The third layer is a waterproof layer made of water-impermeable material such as synthetic rubber.

Because the different materials of the layers have respective properties, they must be separately processed section by section. In the conventional manufacturing method, materials of the surface layer, fiber layer and waterproof layer are separately cut into a plurality of identical sections (such as oval or pentagonal) first. Then the sections are adhered layer by layer in the order. Irregular edges must occur and must be trimmed away. Finally, the trimmed sections are assembled with the others to form a ball.

The method abovementioned has drawbacks of low production efficiency, low yield rate and low accuracy. Furthermore, the more the number of sections required to piece up a ball are, the higher the difficulty of the method is. Thus it has to be improved.

### SUMMARY OF THE INVENTION

A primary object of the invention is to provide a method for manufacturing a ball casing which can manufacture waterproof balls. Also, the balls have great flexibility and expandability.

A secondary object of the invention is to provide a method for manufacturing a ball casing which can enhance production efficiency, yield rate and accuracy.

To accomplish the above objects, the method of the invention includes the steps of:

(1) providing a material having a protection layer and a fiber layer adhering therewith;

(2) cutting the material into sections and

(3) piecing together the sections to form a ball casing.

The method first prepares a whole material formed by multiple layers and then cut it into sections. This may simplify the manufacturing process and increase yield rate. Besides, a pattern layer may additionally be disposed on the fiber layer to further improve integrality and showing.

### BRIEF DESCRIPTION OF THE DRAWINGS

FIG. 1 shows the material in bundled status;

FIG. 2 is an assembled cross-sectional view of FIG. 1 along the line B-B′;

FIG. 2A is a disassembled cross-sectional view of FIG. 1 along the line B-B′;

FIG. 3 shows sections formed on the material;

FIG. 4 shows the piecing of sections;

FIG. 5 shows the assembled ball casing pieced by the sections;

FIG. 6 is an assembled cross-sectional view of the second embodiment of the invention; and

FIG. 7 is a disassembled cross-sectional view of the second embodiment of the invention.

### DETAILED DESCRIPTION OF THE INVENTION

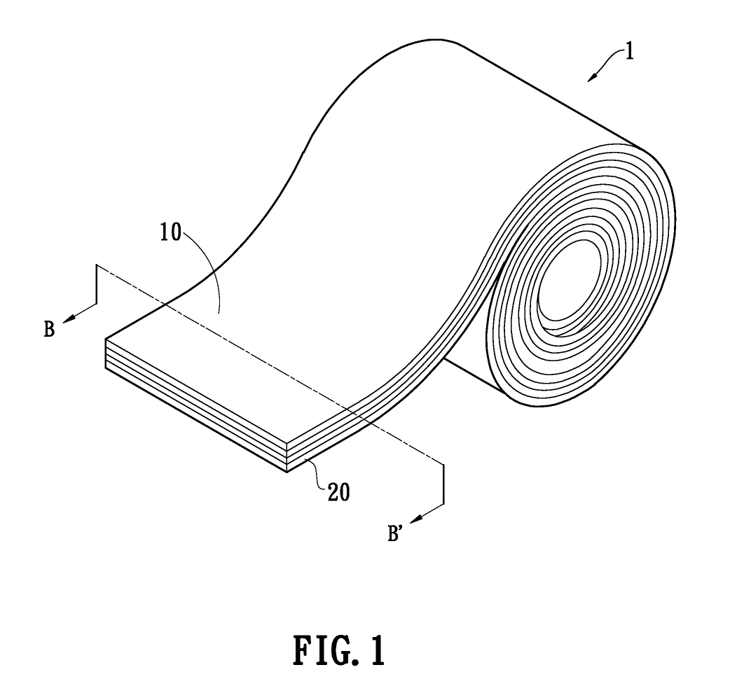

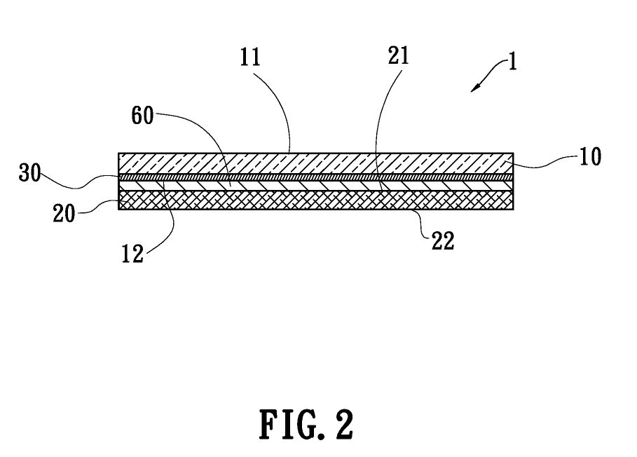

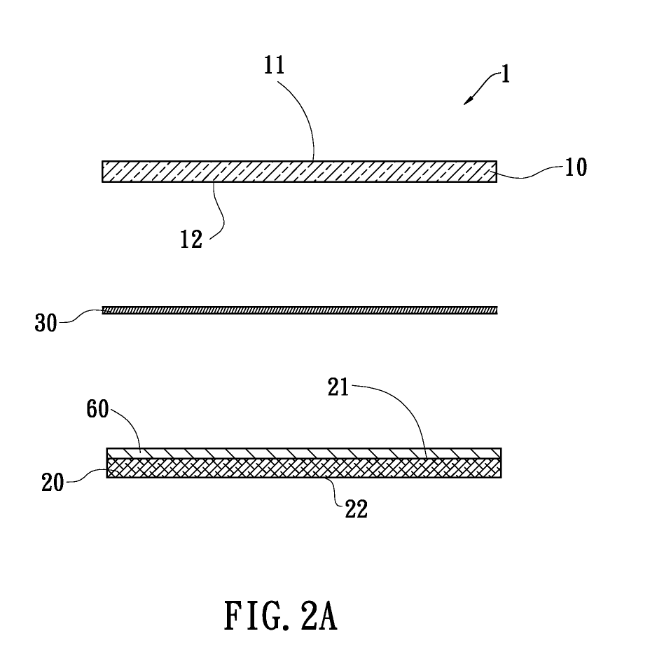

Please refer to FIGS. 1 and 2. The method for manufacturing a ball casing includes the following steps:

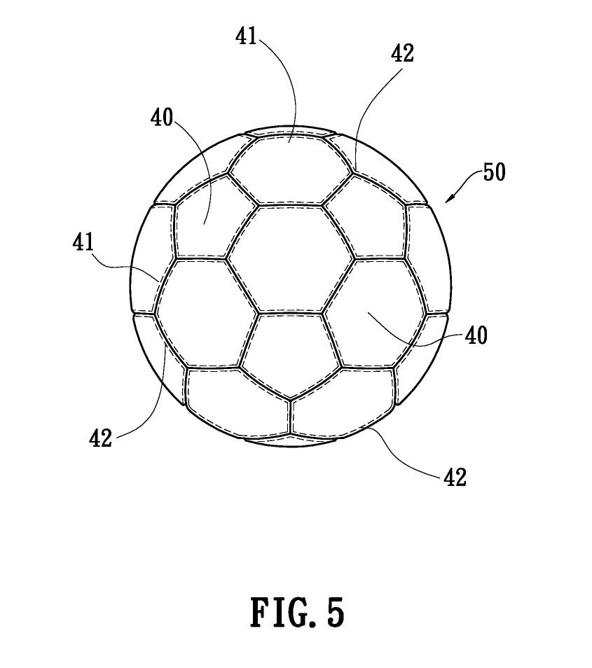

(1) Provide a material 1 for forming a ball casing 50 as shown in FIGS. 2, 2A and 5. The material 1 includes a transparent or light-permeable protection layer 10 having a first side 11 and a second side 12 and a fiber layer 20 having a first side 21 and a second side 22, wherein the first side 11 of the protection layer 10 is smooth or granular, and the first side 21 of the fiber layer 21 is made of natural or artificial fiber and adhered with the second side 12 of the protection layer 10 by an adhesive layer 30.

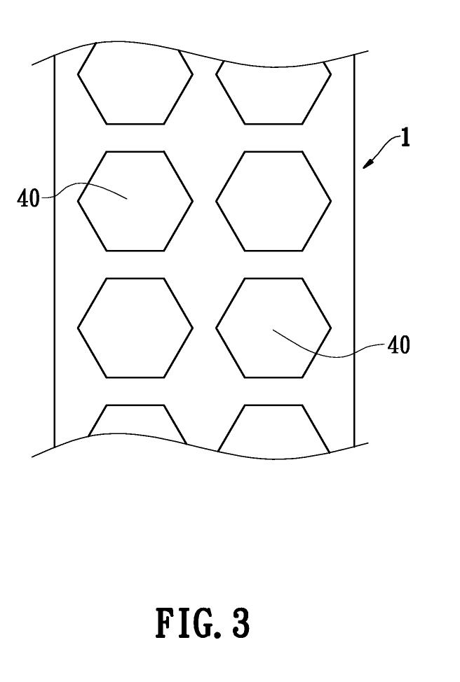

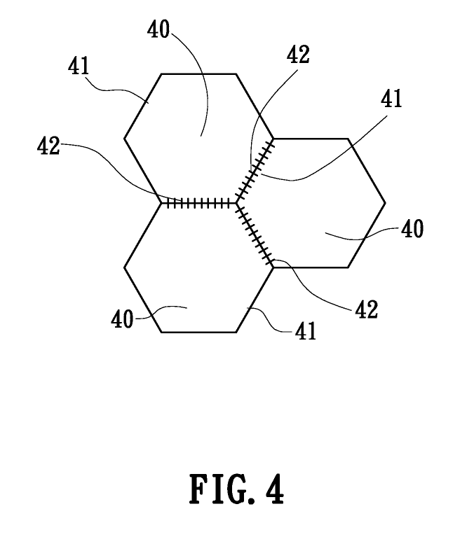

(2) The material 1 is cut into sections 40 as shown in FIGS. 3 and 4.

(3) The sections 40 are pieced together along marginal edges 41 thereof by a thread 42 or adhesive to form a ball casing 50 as shown in FIG. 5. A bladder (not shown) is disposed in the ball casing for inflation.

Please refer to FIGS. 2 and 2A. Preferably, the first side 21 or the second side 22 of the fiber layer 20 may be added a pattern layer 60 by printing and dyeing or weaving. The pattern layer 60 has a colored planar or stereoscopic pattern and is sandwiched between the fiber layer 20 and the protection layer 10.

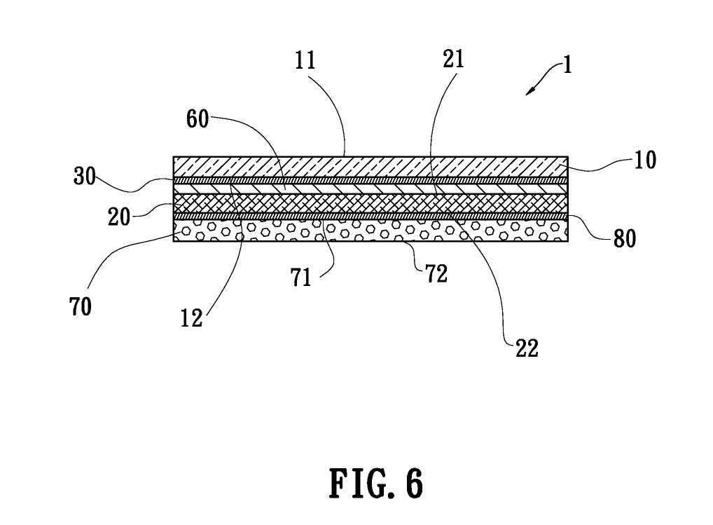

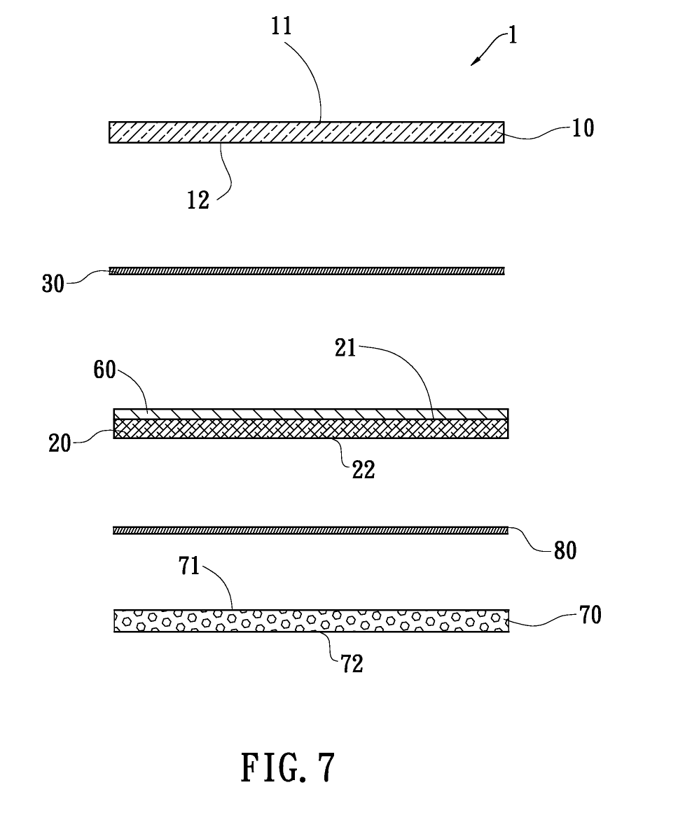

Please further refer to FIGS. 6 and 7, which show another embodiment of the invention. The embodiment includes the following steps:

(1) Provide a material 1 for forming a ball casing 50. The material 1 includes a transparent or light-permeable protection layer 10 having a first side 11 and a second side 12, a fiber layer 20 having a first side 21 and a second side 22, and a sponge layer 70 having a first side 71 and a second side 72, wherein the first side 11 of the protection layer 10 is smooth or granular, the first side 21 of the fiber layer 21 is made of natural or artificial fiber and adhered with the second side 12 of the protection layer 10 by an adhesive layer 30, and the first side 71 of the sponge layer 70 is adhered with the second side 22 of the fiber layer 20 by a bonding layer 80.

(2) The material 1 is cut into sections 40 as shown in FIGS. 3 and 4.

(3) The sections 40 are pieced together along marginal edges 41 thereof by a thread 42 or adhesive to form a ball casing 50 as shown in FIG. 5. A bladder (not shown) is disposed in the ball casing for inflation.

The sponge layer 70 may provide a soft tactile impression. The balls with the sponge layer 70 will be particularly suitable for games or recreation.

Similarly, the first side 21 or the second side 22 of the fiber layer 20 may be added a pattern layer 60 by printing and dyeing or weaving. The pattern layer 60 has a colored planar or stereoscopic pattern and is sandwiched between the fiber layer 20 and the protection layer 10.

It will be appreciated by persons skilled in the art that the above embodiments have been described by way of example only and not in any limitative sense, and that various alterations and modifications are possible without departure from the scope of the invention as defined by the appended claims.

1. A method for manufacturing a ball casing, comprising the steps in the order named:
a) providing a material having a protection layer and a fiber layer, wherein the protection layer has a first side and a second side, the fiber layer has a first side and a second side, and the first side of the fiber layer is adhered with the second side of the protection layer;
b) cutting the material into sections; and
c) piecing together the sections along marginal edges thereof to form a ball casing.

2. The method of claim 1, further comprising a sponge layer having a first side and a second side, wherein the first side of the sponge layer is adhered with the second side of the fiber layer by a bonding layer.

3. The method of claim 1, further comprising an adhesive layer between the first side of the fiber layer and the second side of the protection layer.

4. The method of claim 1, wherein the protection layer is transparent or light-permeable.

5. The method of claim 1, wherein the first side of the protection layer is smooth or granular.

6. The method of claim 1, wherein the fiber layer is made of natural or artificial fiber.

7. The method of claim 1, wherein the first side or the second side of the fiber layer is provided with a pattern layer.

8. The method of claim 7, wherein the pattern layer has colored planar or stereoscopic pattern.

9. The method of claim 1, further comprising a bladder inside the ball casing.

10. The method of claim 1, wherein the sections are pieced together by a thread or adhesive.

11. The method of claim 3, wherein the adhesive layer is an adhesive.

12. The method of claim 1, wherein the first side of the sponge layer is adhered with the second side of the fiber layer by a bonding layer.

13. The method of claim 12, wherein the bonding layer is an adhesive.
